(19) United States
(12) Patent Application Publication
(10) Pub. No.: US 2026/0346854 A1
(43) Pub. Date: Nov. 5, 2026

(54) TOOL FOR ESTIMATING ROLLING AND AIR RESISTANCE FACING A VEHICLE USING A ROLL-DOWN TEST AND GOAL PROGRAMMING

(71) Applicant: Oregon State University, Corvallis, OR (US)

(72) Inventors: David Hamilton, Corvallis, OR (US); John Sessions, Corvallis, OR (US)

(73) Assignee: Oregon State University, Corvallis, OR (US)

(21) Appl. No.: 19/195,567

(22) Filed: Apr. 30, 2025

(51) Int. Cl. B60W 40/10

(52) U.S. Cl. CPC B60W 40/1005; B60W 2520/10; B60W 2520/16; B60W 2530/20; B60W 2552/15; B60W 2555/20; B60W 2556/50

(57) ABSTRACT

A computer-implemented roll-down test tool and apparatus for estimation of rolling and air resistances of a vehicle is disclosed. The apparatus includes a data processing module on board a vehicle, a sensor network comprising one or more vehicle sensors coupled to the data processing module and a human-machine interface module coupled to the data processing module. The roll-down test tool comprises a goal programming model that computes static and dynamic rolling and air resistance parameters by finding one or more feasible solutions for a set of closed form equations of motion by minimizing deviations due to measurement errors of initial and end velocities of the vehicle and elapsed time for each roll-down test observation, where the feasible solutions satisfy all of the equations of motion for each observation of the roll-down test.

### STATEMENT OF GOVERNMENT INTEREST

This invention was made with government support under DE-SC0024965 awarded by the U.S. Department of Energy. The Government has certain rights in the invention.

### BACKGROUND

Presently in the United States, domestic truck tonnage shipped totaled 11.18 billion tons of freight in 2024, and the nation's trucking freight bill totaled $987 billion in gross freight revenues. Naturally, the cost of transporting these goods is a key consideration for fleet owners and manufacturers. One of the factors in determining the cost of transporting goods is fuel cost, which is directly related to the rate at which a vehicle consumes energy as it travels. The ability to predict a vehicle's energy consumption accurately depends on understanding the forces acting upon it. The challenge lies in accounting for variables such as vehicle weight, tire condition/pressure, surface roughness, environmental conditions, and aerodynamics. Traditional vehicle manufacturers have developed complex models that often require controlled environments or expensive equipment to determine resistance values. A more efficient and realistic data collection and analysis system is desired to provide accurate and reliable energy consumption data based on real road conditions.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical examples can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1 illustrates an environmental diagram of a roll-down test of truck 100, in accordance with at least one embodiment.

FIG. 2 illustrates a block diagram showing an exemplary vehicular testing system comprising a data processing module, a vehicle sensor network, and a human-machine interface module, in accordance with at least one embodiment.

FIG. 3 illustrates a flow diagram for the roll-down tool application, in accordance with at least one embodiment.

FIG. 4 shows a plot of a road segment slope taken by a land surveyor, in accordance with at least one embodiment.

FIG. 5 shows an example of a road grade profile for a segment of road, in accordance with at least one embodiment.

FIG. 6 shows a contour map of the same road segment shown in profile in FIG. 5.

FIG. 7 illustrates a flowchart for a method of performing a roll-down test for a vehicle under test using a roll-down tool application that applies goal programming to find rolling and air resistance parameters, in accordance with at least one embodiment.

### DETAILED DESCRIPTION

Described herein is a method and apparatus for obtaining realistic and accurate air and rolling resistance measurements of trucks, vans, sports utility vehicles (SUVs) and passenger cars. The disclosed tool processes velocity and time data from roll-down tests, where the raw data are input to a computational tool interfaced to sensors within the vehicle to calculate rolling resistance of the vehicle under the particular road conditions and vehicle conditions. The disclosed method and apparatus include a computer-implemented sensor interface and computational tool to determine accurate rolling and air resistances of road vehicles. In a key aspect of the disclosed method and apparatus, employment of the disclosed tool enables determination of rolling and air resistances in real time and under actual road and vehicle conditions. Currently, rolling and air resistances of vehicles may be determined empirically by wind tunnel tests. Such tests do not consider road conditions such as surface roughness, slope, tire pressures and tread wear, etc. Secondly, mathematical models have been developed for estimating rolling resistances but may not utilize data garnished by real vehicle testing conditions as can obtained by a roll-down test. For the latter, some parameters may be assumed and therefore may not be realistic. Thirdly, realistic roll-down test data may be collected and input to a computational tool implementing such mathematical models, but either experimental roll-down data may not be reliable or the computational tool does not minimize errors in the data. Either inaccurate input to the model or the model itself may be inadequate, potentially producing rolling and air resistance results having poor accuracy.

The disclosed apparatus and method greatly improve accuracy of rolling and air resistance calculations by allowing data collection through a roll-down test under actual operating conditions and utilizes Goal Programming to solve resistance coefficients with minimum error. Goal programing considers errors that may be present in the calculated results due to inaccuracies of input data.

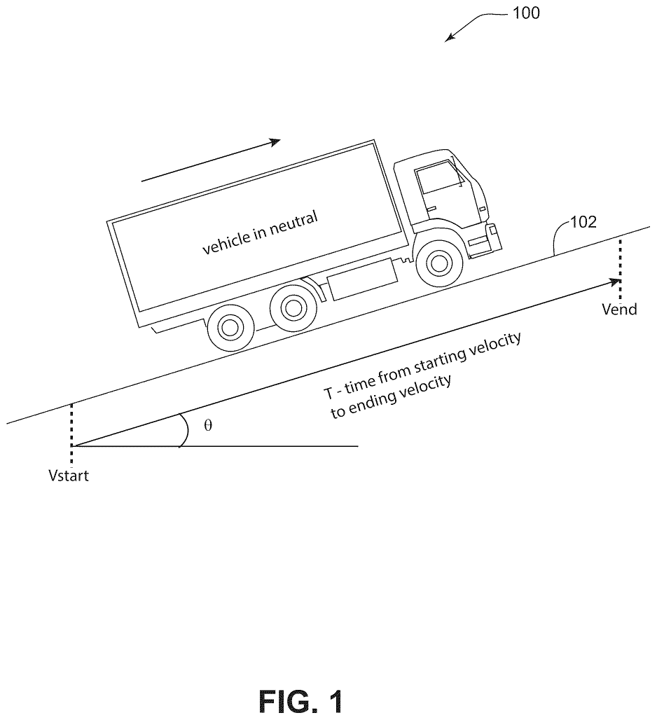

FIG. 1 illustrates an environmental diagram of a roll-down test of truck 100, in accordance with at least one embodiment. Here, the roll-down test occurs on an uphill section of road 102 having a consistent slope denoted by an angle θ. The data observation data collected for the disclosed tool are starting and ending velocities and time between those observations. In at least one embodiment, data is collected automatically, where a human-machine interface is coupled to one or more sensors within the vehicle. To perform a roll-down test, a driver of the vehicle under test (VUT) may program initial conditions involving geographic coordinates (e.g., latitude and longitude generally obtained from GPS or other GNSS (global navigation satellite system) services. Such data may be obtained automatically by a vehicle-borne computer or computing device (e.g., a laptop computer, a tablet or a smart phone). In some examples, a driver of the VUT may initiate the roll-down test by manually tapping a button on a touchscreen or by clicking using a mouse or trackpad on same, by voice activation, gesture, or other means of input to a vehicle-borne computer. In some embodiments, the on-board computing device may be wirelessly communication with a remote network that may query the vehicle-borne computing device for its GPS coordinates as it is traveling.

In some embodiments, a vehicle-borne computing device may continuously obtain GPS coordinates with an on-board GPS receiver. The vehicle-borne computing device may store one or more digital road maps, of which a software application may open a digital map based on the GPS coordinates to pinpoint the VUT location with regards to a particular road upon which it is travelling, then determine its direction of travel. The software application may determine the grade of a section of road that is in front of the VUT, based on geographic information (e.g., elevation data) obtained from the digital map. The VUT may continually update the software application with current GPS coordinates. By rate of speed of the VUT determined from the updates of the GPS coordinates, the software application may anticipate a section or road in the direction of travel of the VUT having a substantially constant ascending grade for a predetermined distance. In some embodiments, a descending grade may be used. As the vehicle approaches the selected graded section of road, the software application may indicate to the driver that a roll-down test will commence in some predetermined number of seconds, for example to start the test in 5 seconds, and that the driver will receive an audible or visual starting mark, then allow the vehicle to coast until the speed of the VUT falls to a predetermined value or until the VUT has travelled a specified distance. In some embodiments, the driver may take their foot off the accelerator at the starting mark and shift the transmission of the VUT to neutral position to conduct the test. The driver may receive a finish mark at the end of the test.

In some embodiments, the software application may have access to vehicular sensor data that inputs VUT velocity and may also include ancillary data such as engine torque, engine speed, and wheel speed. The software application may store start and endpoint VUT velocities. The elapsed time of the test may also be stored. Knowing the road grade, the angle of ascent may be computed and stored. The angle of ascent is input to a computational algorithm of the software application that computes rolling and air resistance of the vehicle. Road conditions, such as surface type (e.g., paved, gravel, dirt), may also be known from GIS (geographic information system) data taken from the digital map.

Meteorological conditions may also be obtained by the software application either at the time of the roll-down test or after. Meteorological data may include prevailing wind speed and direction, air temperature, and precipitation, if any. The principal data that are input to the rolling and air resistance computational algorithm are grade angle, start and endpoint velocities of the VUT, as well as the elapsed time for the roll-down test, where the elapsed time is the time to reach the endpoint of the test from the start point. In addition to the foregoing parameters, the vehicle weight is also input to the algorithm. If the VUT is a truck, for example, the vehicle weight may be known for the vehicle as its net, or unloaded, weight. If the VUT carries a load (e.g., VUT is loaded) at the time of the roll-down test, gross weight of the VUT is known and entered. In this manner, the rolling resistance and air resistance data may be known for both the loaded and unloaded states.

In at least one embodiment, the computational algorithm employs the following function to compute rolling resistance and air resistance.

$$t = \frac{{m}^{′}}{\sqrt{a b}} [ {tan}^{- 1} ( {v}_{1} \sqrt{( b / a )} ) - {tan}^{- 1} ( {v}_{2} \sqrt{( b / a )} ) ] \qquad [ 1 ]$$

Here, v1 and v2 are start and stop velocities of the roll-down test for the VUT. The parameters α and b are terms in an equation for total mechanical resistance R of the VUT, where

R=α+bv² [2]

Here, v is vehicular speed and is explained below. The function expressed by equation [1] determines a and b to compute R in equation [2]. Parameter α is the static component of rolling resistance of the vehicle plus the grade resistance. Parameter b is the dynamic component of the rolling resistance plus drag coefficients for air resistance. Parameters α and b are defined below.

Equation [1] is a closed form solution of elapsed time of the roll-down test as a function of start and stop velocities, resistance parameters α and b, and equivalent vehicle mass m′. The equivalent mass m′ is determined after adjustment for the energy of the vehicle's rotating wheels, as explained below. The closed form of such a highly nonlinear equation enables algebraic and other standard solution methods to be applied to equation [1], which is a continuous function, for determining parameters α and b of which it is a highly nonlinear function. In contrast, discrete (open-form) functions rely on purely discretized numerical methods that would use iterative methods and mapping to finite elements that approximate continuous functions, for example, yielding more approximate results. Thus, methods such as goal programming may be readily applied to solve equation [1] as a closed form equation, allowing a more efficient and less resource and time-consuming computation that would be necessary for solving an open-form function.

The equivalent mass m′ of the vehicle may be expressed in the following equation [3]

m′=m+mₑ [3]

where m is the mass of the vehicle in kg, and mₑ is an effective mass based on the energy of the rotating wheels of the vehicle, derived from equations [4] and [5]:

$$E = \frac{m {v}^{2}}{2} + I \frac{{ω}^{2}}{2} \qquad [ 4 ]$$

mₑ=ΣI/r² [5]

where E is the total energy of the vehicle, I is the moment of inertia of rotation of the wheels in kg-m², ω is the rotational velocity is rev/sec and r is the radius of the wheels in m.

From equation [4], it may follow that:

dE=m′v dv [6]

where it follows that the energy is a sum of individual energies spent on overcoming the various resistive forces applied to the vehicle:

dE=ΣR dS [7]

m′v dv=ΣR dS [8]

$${m}^{′} \frac{d S}{dt} d v = \sum R d S \qquad [ 9 ]$$

ΣRdt=m′dv [10]

The elapsed time may be obtained by rearranging equation [8] and integrating to obtain equation [12]:

$$d t = \frac{{m}^{′} dv}{\sum R} \qquad [ 11 ]$$

$$t = {m}^{′} {\int }_{{v}_{2}}^{{v}_{1}} ( \frac{dv}{\sum R} ) \qquad [ 12 ]$$

However, the sum of the rolling, air and grade resistances may be obtained by following set of equations:

R_{rolling}=(k₁)W cosθ [13]

R_{rolling}=(k₁+k₂v²)W cosθ [14]

Rₐᵢᵣ=k₃v² [15]

R_{grade}=W sinθ [16]

where R_{rolling}, Rₐᵢᵣ and R_{grade} are the corresponding resistances in units of kgf, k₁, k₂ and k₃ are frictional and drag coefficients, v is the velocity of the VUT, W is the weight of the VUT, and θ is the incline angle of the grade. While MKS units are given in this disclosure, the unit of kgf is “kilogram force,” is not part of the MKS unit system. However, the kgf is equivalent to one Newton in the MKS system of units, e.g., a mass of one kilogram multiplied by the standard value for gravitational acceleration, or 9.81 m/s². Terms containing sinθ are horizontal force components, whereas terms containing cosθ are vertical force components. As will be shown below, the coefficients k₁, k₂ and k₃ are embedded in the parameters α and b. As is further shown below, these coefficients may be extracted once α and b are determined.

The air drag resistance Rₐᵢᵣ (e.g., equation [15]) is a quadratic function of vehicle velocity, and k₃ is given in units of kgf-s²-m⁻². R_{rolling} is composed of two terms, one velocity-independent term comprising k₁ and a velocity-dependent term comprising k₂. Coefficient k₁ is a static coefficient of R_{rolling} (e.g., k₁ is a frictional force coefficient proportional to road friction). This term may consider frictional resistance due to the road surface and its interaction with the tires. For example, a gravel surface may have greater friction, thus a larger k₁ coefficient, than a paved surface. The tire tread may also be convoluted into k₁ to a lesser degree. The rolling coefficient k₂ is the dynamic coefficient of rolling resistance R_{rolling}, and expressed in units of kgf-s-m⁻¹. The dynamic term varies with vehicular velocity. At speeds lower than 30 mph (50 km/h), R_{rolling} is largely independent of velocity, and equation may be invoked. At speeds greater than 50 km/h, equation may be invoked. At speeds above 100 km/h, R_{rolling} develops an increasingly nonlinear dependence on velocity. R_{grade} (e.g., equation [16]) is independent of velocity, and is the resistance due to gravitational drag.

Terms in equations 13-16 may summed to produce a total combined resistance in equation [17], then rearranged to produce a polynomial of the variable v in equation [18], as shown below:

Rₜₒₜ=(k₁+k₂v²)W cosθ+k₃v²+W sinθ [17]

Rₜₒₜ=(k₁W cosθ+W sinθ)+(k₂W cosθ+k₃)v² [18]

Equation may be simplified by substitution of variables α and b for the quadratic terms in equation [19]:

Rₜₒₜ=α+bv² [19]

where α combines the static component of rolling resistance and the grade resistance, while b combines the dynamic rolling resistance and the vehicular drag coefficients, both having units of kgf-sec²-m⁻². Equating Rₜₒₜ to a force m′a, where m′ is the effective mass of the VUT defined in equation [3] and a is an acceleration of the VUT, by application of Newton's second law it may be shown that an elapsed time between a starting velocity of the roll-down test and an ending velocity of the roll-down test may be expressed as equation [20]:

$$t = {m}^{′} {\int }_{{v}_{2}}^{{v}_{1}} \frac{dv}{a + b {v}^{2}} \qquad [ 20 ]$$

Integration of equation yields a nonlinear closed form solution of an equation of motion of a VUT undergoing a roll-down test, having elapsed time t of the roll-down test as a function of variables m′, v₁, v₂, α, and b:

$$t = \frac{{m}^{′}}{\sqrt{a b}} [ {tan}^{- 1} ( {v}_{1} \sqrt{( b / a )} ) - {tan}^{- 1} ( {v}_{2} \sqrt{( b / a )} ) ] \qquad [ 21 ]$$

Solution of equation for forward motion resistance parameters α and b may be obtained by inputting start and end velocities v₁ and v₂ experienced by the vehicle undergoing the roll-down test. Because a unique solution for the two unknown variables α and b is sought, two equations are needed and may be solved simultaneously. Thus, at least two observations during the roll-down test may be performed to obtain two sets of velocity data and elapsed time t sets for input to equation [21] for a simultaneous solution to yield α and b. As velocities and elapsed time are measured quantities, some error may inevitably be present in the measured data. Identification of a feasible solution may be challenging due to the nonlinearities in the elapsed time equation as well as measurement error, thus a goal programming approach may be taken by introducing deviation variables of unrestricted sign e into equation [21], as shown in equations of motion and [23]:

$${t}_{1} = \frac{{m}^{′}}{\sqrt{a b}} [ {tan}^{- 1} ( {v}_{1} \sqrt{( b / a )} ) - {tan}^{- 1} ( {v}_{2} \sqrt{( b / a )} ) ] + {ϵ}_{1} \qquad [ 22 ]$$

$${t}_{2} = \frac{{m}^{′}}{\sqrt{a b}} [ {tan}^{- 1} ( {v}_{3} \sqrt{( b / a )} ) - {tan}^{- 1} ( {v}_{4} \sqrt{( b / a )} ) ] + {ϵ}_{2} \qquad [ 23 ]$$

Equations and represent two roll-down observations denoted by runs 1 and 2, where t₁ and t₂ are elapsed time for each observation set. Variable t₁ is the elapsed time between v₁ and v₂, whereas t₂ is the elapsed time between v₃ and v₄. While two equations are shown for solution of variables α and b, more than two observations may be taken to reduce error by an increase of sample size or to increase the velocity range. If more than two observations are taken, the minimization of the deviation variables is like regression analysis. Minimizing the sum of the deviations rather than the square of the sum of the deviations may be an efficient estimator of road properties when there will be only a small sample, such as may involve only one pass over a road segment. In addition, repeating the roll-down test over the same road segment at different starting velocities can enable a shorter test strip. The goal programming approach employed in the disclosed method can provide improved estimates of energy requirements based on road condition and air resistance under an actual truck configuration, load conditions and road conditions of the day.

Deviation or error terms ϵᵢ are included in equations and [23], which may be minimized to reduce any infeasibilities and produce a feasible solution. Thus, a minimization function may be obtained as equation [24]:

$$min {\sum }_{1}^{n} \vert {ϵ}_{i} \vert \qquad [ 24 ]$$

Here, the sum of deviations

$${\sum }_{1}^{n} \vert {ϵ}_{i} \vert$$

is minimized wo arrive at a feasible solution for α and b, where n is the number of runs. In an example, five observations may be performed to obtain five data sets of t, vₛₜₐᵣₜ and v_{end}. The runs may be repeated at different starting velocities to obtain a wider time-velocity profile. A steeper grade may also be tested, enabling shorter test distances. Note that if the specific nonlinear optimizer does not permit variables to be negative, then the well-known technique of adding a slack variable minus a surplus variable to each equation achieves the same result.

Once variables α and b are determined, the total resistance of the VUT may be computed using equation [19]. In a particular example, the same vehicle may be tested in an unloaded and loaded state. If the vehicle has the same aerodynamic shape in both the loaded and unloaded states (e.g., a chip van), coefficients k₂ and k₃ may be extracted by means of equations [25] through [31], enabling extraction of k₁ from equation [18]:

R_{loaded}=α_{loaded}+b_{loaded} v²[25]

R_{unloaded}=α_{unloaded}+b_{unloaded} v²[26]

b_{loaded}=k₂W_{loaded}+k₃[27]

b_{unloaded}=k₂W_{unloaded}+k₃[28]

k₃=b_{loaded}-k₂W_{loaded}[29]

b_{unloaded}=k₂W_{unloaded}+b_{loaded}−k₂W_{loaded}[30]

k₂=(b_{unloaded}−b_{loaded})/(W_{unloaded}−W_{loaded})[31]

For a VUT having a different aerodynamic profile in the unloaded and loaded states (e.g., a logging truck), the truck in either state may be tested on two different road grades with the same surface conditions having inclination angles θ₁ and θ₂. By analogy with equations [17]-[19], equations [32]-[40] may be invoked to determine coefficients:

R₁=(k₁W cos θ₁+W sin θ₁)+(k₂W cos θ₁+k₃)v² [32]

R₂=(k₁W cos θ₂+W sin θ₂)+(k₂W cos θ₂+k₃)v² [33]

R₁=α₁+b₁v² [34]

R₂=α₂+b₂v² [35]

b₁=k₂W cos θ₁+k₃ [36]

b₂=k₂W cos θ₂+k₃ [37]

k₃=b₁−k₂W cos θ₁ [38]

b₂=k₂W cos θ₂+b₁−k₂W cos θ₁ [39]

k₂=(b₂−b₁)/(W cos θ₂−W cos θ₁) [40]

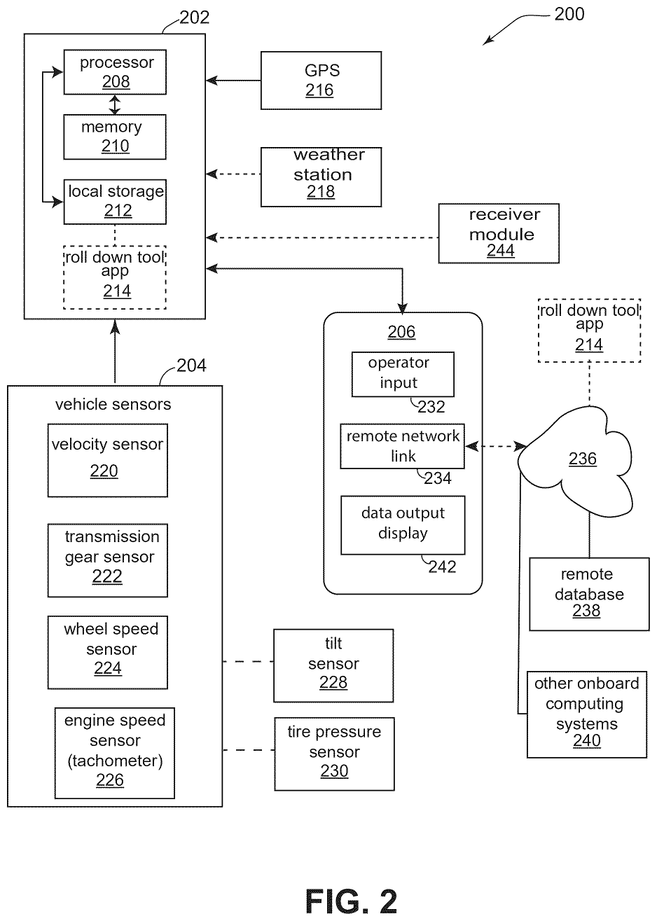

FIG. 2 illustrates a block diagram showing an exemplary vehicular testing system 200 comprising a data processing module 202, a vehicle sensor network 204, and a human-machine interface (HMI) module 206. In at least one embodiment, HMI module 206 is a portable computing device such as a laptop computer, a tablet computer or a smartphone. In at least one embodiment, data processing module 202 is a computer having a processor 208, a memory 210 coupled to processor 208, and a local storage 212 also coupled to processor 208. Local storage 212 may store comprise a non-transitory storage medium such as a magnetic hard drive or a solid-state drive. Local storage 212 may store a software application for execution of a roll-down test protocol (roll-down tool application 214) by processor 208, where the application is described below. In some embodiments, roll-down tool application 214 is optionally stored in local storage 212. In some embodiments, roll-down tool application 214 is optionally stored on a remote network (see below). Data processing module 202 may also receive input from a global positioning system receiver 216 to pinpoint an exact position of the VUT. In at least one embodiment, data processing module 202 may optionally receive input from a vehicle-borne weather station 218.

In at least one embodiment, data processing module 202 comprises one or more cabled or wireless interfaces for receiving inputs from vehicle sensor network 204. In at least one embodiment, vehicle sensor network 204 comprises a vehicular velocity sensor 220, a transmission gear sensor 222, a wheel speed sensor 224, and an engine speed sensor 226 (e.g., a tachometer). In some embodiments, a tilt sensor 228 and a tire pressure sensor 230 may be included in a vehicle sensor package to determine a slope of a grade during a roll-down test, as well as tire pressure on at least some of the tires. The latter sensor may also be part of a standard sensor package that is factory installed. In some embodiments, sensors of vehicle sensor network 204 may be networked on a controller area network (CAN) bus.

In exemplary embodiments, vehicular velocity sensor 220 may comprise a velocity sensor native to the VUT. For example, a factory-installed velocity sensor that detects revolutions per minute (rpm) of a wheel for computation of vehicle speed that is displayed to the driver may be employed.

Generally, the roll-down test may be conducted with the engine disengaged with the drive train of the VUT. However, if the engine is engaged, there is to be no power transferred to the wheels, thus the operator of the VUT may proceed with the roll-down test having no foot on the accelerator pedal, for example. Choice of engine engagement may be controlled by the gear selector position of the vehicle's transmission. For example, the transmission may be placed in neutral during the test, disengaging the engine. For tests conducted with the engine engaged, an automatic transmission may be placed in drive for automatic gear selection in fixed gear ratio automatic transmissions or continuously variable transmissions (CVT). In some implementations, a gear may be selected manually with some automatic transmissions and all manual transmissions. In some embodiments, information from the transmission may be accessible through a data interface coupled to the on-board computer of the VUT. In some embodiments, a combination of engine speed data and gear ratio data may be employed to estimate or determine the torque of the engine placed on the drive train to move the VUT at a particular velocity or wheel speed. If the engine is engaged, the engine torque may indicate the overall motive force necessary to overcome resistance forces tending to impede forward motion of the VUT during a roll-down test. Here, the effective mass m′ calculation (e.g., see Eqs. [3]-[5]) of the vehicle may consider inertia of the engine and transmission and other drive train components. However, this may introduce more uncertainty in the elapsed time equations of motion (e.g., Eq. [21]).

For a roll-down test, the principal input data to compute forward motion resistance parameters include grade slope angle, start velocity, end velocity, and elapsed time. Thus, the roll-down test may be conducted with the engine disengaged from the drive train to eliminate the influence of the engine torque and drive train losses on vehicular velocity, thus isolating gravity, road surface friction, and air resistance as the only forces on the VUT. These ancillary forces may be measured by roll-down tests conducted with the engine engaged. As noted above, the data analysis model holding closed form function of elapsed time may be employed to determine the resistance parameters (e.g., a and b) that compute rolling resistance, air resistance, and grade resistance. If the engine is disengaged with the drive train of the VUT during the roll-down test, the sensors monitored may be restricted to velocity sensor 220 or wheel speed sensor 224, which may be monitored to determine vehicular velocity of the VUT at both start and end marks. A digital clock or timer may determine the precise elapsed time to millisecond precision.

HMI module 206 may be a portable computing device such as a laptop computer, smart phone, or tablet. In some embodiments, HMI module 206 is connected to data processing module 202 either by a cabled connection or by wireless means (e.g., Wi-Fi, Bluetooth or equivalent). Here, an operator of the VUT may input data into an operator input application 232 of HMI module 206. Operator input application 232 may receive driver's notes, whether the vehicle is loaded, gross weight of the loaded vehicle, tire tread depth, and air pressure, if the latter parameters are to be manually ascertained. Data such as the unloaded weight of the VUT, tire size, and effective mass of the VUT (e.g., see equation [3] above) may be predetermined and input as constants to the roll-down tool application 214 in advance of the roll-down test.

In at least one embodiment, ancillary data such as weather information and GPS position may be automatically input to the roll-down tool application 214 by GPS receiver 216 and on-board weather station 218. Weather information may contain wind speed and direction data, as well as temperature and precipitation data. Such parameters may influence the elapsed time data from the roll-down test and may be considered by roll-down tool application 214.

In at least one embodiment, HMI module 206 is configured to provide a wireless link 234 to a remote network 236. For example, HMI module 206 may provide connectivity to a cellular network that accesses the internet. In some embodiments, roll-down tool application 214 may not be stored locally in local storage 212, but may be optionally stored in remote network 236 and accessible by processor 208 through remote network 236. A remote database 238 may also be included in the remote network 236 for retention of roll-down test data. In some embodiments, onboard computing systems 240 of other vehicles may be networked together through remote network 236. Data from the roll-down test may be displayed to the operator on a data output display 242.

In at least one embodiment, a receiver module 244 is coupled to data processing module 202. Receiver module 244 may receive wireless signals from an external transmitter and may be configured to start or end a data acquisition process. Such wireless signals may include a photodetection signal, where the VUT breaks an optical path between a light source and a photodetector (both external to the VUT), where a signal is sent to receiver module 244 when the VUT crosses the light path. For example, an optical triggering system set up at a test strip would satisfy this configuration. A sonar or radar system may also be employed in a similar fashion. Here, a wireless signal may be sent to receiver module 244 when the VUT reaches a predetermined position on a test strip. Upon reception of the wireless signal, receiver module 244 may send a secondary signal to data processing module 202, whereupon data acquisition, including acquiring vehicle speed, slope, and timing data, may be initiated or ended. An example of a wireless signal may be radio transmission in the UHF or microwave bands.

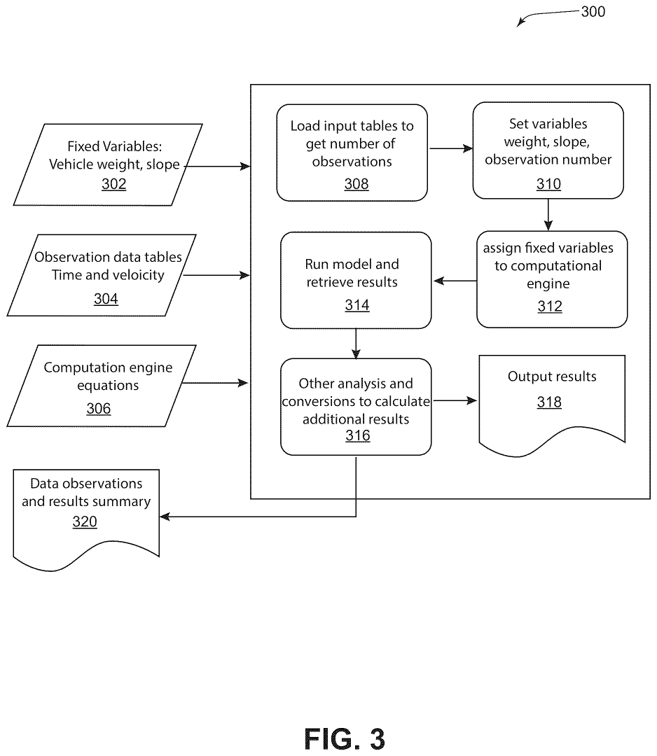

FIG. 3 illustrates a flow diagram for the roll-down tool application 300, in accordance with at least one embodiment. Roll-down tool application 300 is configured to execute a set of instructions that may be stored in local storage 212 or on a server in remote network 236. For example, processor 208 may execute instructions in roll-down tool application 300 within data processing module 202 onboard the VUT. At block 302, fixed variables such as, for example, vehicle weight and grade slope, are loaded into the roll-down tool application. The fixed variables may be supplied by an operator through the interface of operator input application 232 of HMI module 206 or obtained by a sensor input through vehicle sensor network 204. A wireless weight gauge or scale may transmit loaded vehicle weight, for example. An on-board tilt sensor (e.g., tilt sensor 228), such as a gyroscope or an electronic tilt sensor may input a grade slope in real time. Grade slope angle data may also be retrieved from digital maps stored in a local storage in data processing module 202 (e.g., local storage 212), which is on board the VUT. Grade slope angle data may also be retrieved from a cloud-based database (e.g., remote database 238) when given the VUT's GPS coordinates. Geospatial data (e.g., GPS coordinates) may be supplied from a GPS receiver, such as GPS receiver 216.

At block 304, observation data containing roll-down test data, such as start and end velocities, as well as elapsed time, are input to roll-down test application 300. In some embodiments, these data may be in the form of spreadsheet files or other suitable data formats. For example, sensor data giving vehicle velocity (e.g., measured by wheel speed sensor 224 or velocity sensor 220) may be transmitted from vehicle sensor network 204 and acquired automatically by data processing module 202 on board the VUT. Elapsed time may be input to the application by a manual or automatic timing system that marks the start and stop times for the roll-down test. In some embodiments, the elapsed time is recorded with millisecond accuracy. Here, the roll-down test may be automatically initiated, where the operator of the VUT may manually generate a start mark or trigger the application to autonomously initiate the test. In some embodiments, a high-accuracy clock in data processing module 202, HMI module 206, GPS, or an internet clock resource may be employed for obtaining timing data with a high accuracy. In some embodiments, an operator of the VUT may manually input elapsed time data.

At block 306, the computation engine may provide a computational algorithm for determining forward motion resistance parameters to roll-down tool application 300. For example, the computational algorithm may comprise equations and derived above for determining rolling and air resistances of the VUT on the road segment. Several equation solvers capable of solving simultaneous nonlinear equations may be available to incorporate as computational engines into the roll-down test application 300 (for example, LINGO®, Sage, FriCas, MatLab®, SciLab, Maxima, Mathematica®, Maple®, Math Works® fsolve, Octave, Polymath Plus, to name a few). In some embodiments, the computational engine may be accessed by roll-down tool application 300 as a subroutine or function that is called from a main routine in roll-down tool application 300. The computational engine may be passed observation data set variables including start velocity, end velocity, slope angle, and elapsed time variables obtained at block 304 for each observation. Data sets from any number of multiple observations may be passed as matrices or vectors, for example. Fixed variables such as vehicle weight that are input at block 302 may also be included in the variable list and sent to the computational engine. In some embodiments, ancillary data may also be input, such as engine speed, wheel speed, engine torque, wind speed and direction, and other such data may also be included.

At blocks 308, 310, and 312, input data from blocks 302 and 304 may be parsed and placed in variables and optionally organized into vectors or matrices if data from multiple observations are provided, to be passed to the computational engine by roll-down test tool application 300. If multiple observations are input, deviation variables ϵ for each observation are included in the model equations (e.g., see equations [22] and [23]). As noted above, during the computation process, the deviation variables ϵ are summed and the sum minimized to find one or more feasible solutions.

At block 314, once all variables are passed to the computational engine, the computations are run to determine the forward motion resistance parameters. Here, simultaneous equations are set up comprising a set of equations such as equations [22] and [23] for each observation, the number of which determining the number of constraint equations for the goal program and the number of deviation variables to minimize. A minimum of two data sets for two observations and thus two equations may be employed to solve for the two fundamental resistance parameters α and b, as discussed above. In some embodiments, multiple observations may be more than two for an increase in the feasibility of one or more solutions by minimizing larger numbers of deviation (epsilon) variables ϵ.

At block 316, in some embodiments, other analyses may be performed involving ancillary data mentioned above. For roll-down tests having the VUT engine engaged with the drive train, for example, engine torque may be considered for any additional drag due to engine compression, inertia of the rotating parts and drive train losses from rotational friction.

At block 318, roll-down tool application 300 optionally outputs results of the analysis to the operator(s) of the VUT. The result data may be displayed on a graphical user interface (GUI), for example data output display 242 on HMI module 206. The operator(s) may verify the results. Block 318 may be available optionally as the display may be discretionally toggled as active or inactive.

At block 320, roll-down tool application 300 packages results into a file, which can be sent to a cloud-based database such as remote database 238 and/or local storage 212 in data processing module 202. An example of such a data file may be a spreadsheet table. Such a file may include the fixed variables, input table sets, any ancillary data, and computation results, including rolling and air resistances for the VUT.

Table 1 shows exemplary observation data that may be input to rolldown tool application 300 at block 304. Here, the roll-down test observations are run at different starting velocities on the same road segment. Thus, the slope angle is the same. The distance of the run is not a parameter for the computation, but this may be constant or varied to arrive at different elapsed times as long as the slope is the constant. Another example of an end marker for a multi-observation roll-down test is setting a target end velocity, which can be a constant. If the end velocity is a constant, where all observations terminate when the VUT reaches the target end velocity, then the starting velocity is also the same for each observation. For the constant grade, what varies is the elapsed time. The travel distance going up the grade naturally varies as well, whereby this is a function of the elapsed time. Thus, the constant grade criterion must hold, where the grade variation over a stretch of road is within a predetermined limit.

TABLE 1

| Observation | Time (seconds) | Start Velocity m/s | End Velocity m/s |
|---|---|---|---|
| Obs. 1 | 8.00 | 20.44 | 18.80 |
| Obs. 2 | 9.00 | 20.74 | 18.72 |
| Obs. 3 | 13.00 | 12.99 | 10.76 |
| Obs. 4 | 7.00 | 21.79 | 20.23 |
| Obs. 5 | 12.00 | 15.20 | 13.09 |
| Obs. 6 | 10.00 | 1726 | 15.42 |

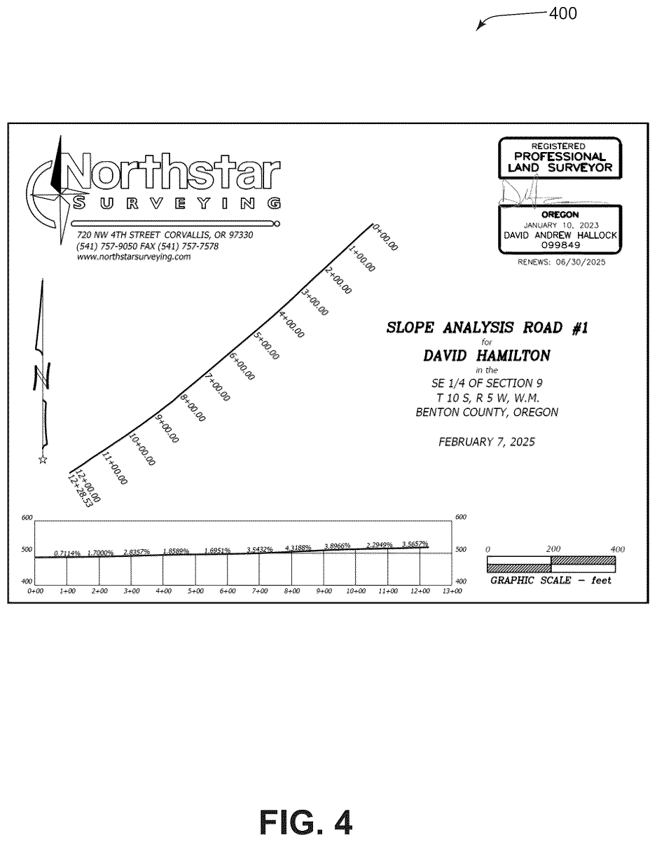

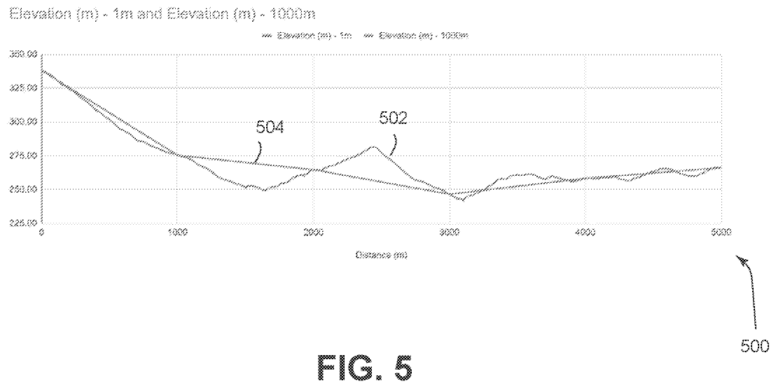

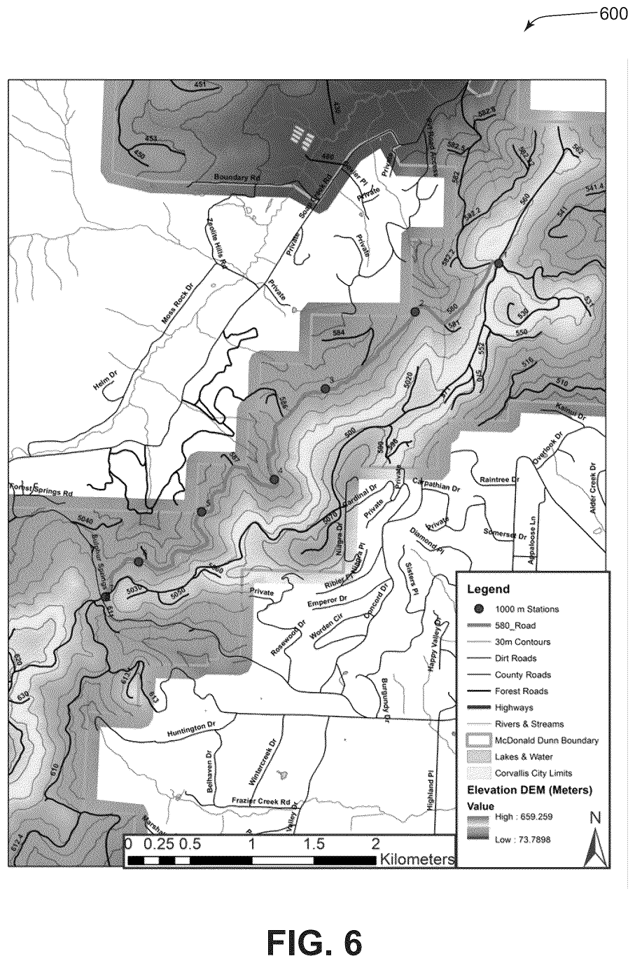

Elapsed time was taken with a GPS atomic clock. An example of a tolerable grade is a 214 ft (approximately 69 m) section of a road having an average grade of 0.66% (e.g., 0.66 foot vertical change per 100 feet of horizontal distance; slope angle of) 0.38°. A land surveyor's slope analysis of the road containing the test segment is shown in plot 400 of FIG. 4. The variation of grade is within 0.5%. Meteorological data included clocked wind speed at 12 mph blowing from the southwest. Temperatures ranged between 52 °F and 58 °F. The vehicle was a loaded tactor trailer diesel truck, having a gross vehicle weight of 33, 450 pounds (15,205 kg; unloaded weight is 24,810 pounds or 11,277 kg). An example of a road grade profile is shown in plot 500 in FIG. 5. Plot 502 (solid line) shows elevation data taken with a resolution of one meter along a 5 km stretch of road. Plot 504 (broken line) shows elevation data for the same 5 km stretch with a 1000-meter resolution. FIG. 6 shows a contour map 600 of the same road segment shown in profile in FIG. 5. The road segment is in the MacDonald-Dunn research forest near Oregon State University.

Using data similar to those shown in Table 1, the computational engine (block 306) solves the elapsed time equations (e.g., see Eqs. [22] and [23]) simultaneously, with a goal to minimize the sum of epsilon variables (e.g., Eq. [24 to obtain a feasible solution for forward motion resistance parameters α and b.

As an example, velocity and elapsed time data similar to the data shown in Table 1 are input to the roll-down tool application 300 for a loaded truck with a 4 mph headwind on a particular test strip has computed a parameter α to be 226.45 kgf, whereby a is a combination of the static component of rolling resistance plus the grade resistance. The parameter b was found to be 0.3262 kgf-s²-m⁻², whereby b is a combined coefficient combining the dynamic rolling resistance coefficient plus the vehicle drag resistance coefficient. For an unloaded truck with a 10 mph tailwind, the a parameter is 225.07 kgf, and b parameter 0.3156 kgf-s²-m⁻² on the same test strip. From parameters α and b, rolling resistance R_{rolling}, air resistance Rₐᵢᵣ, grade resistance R_{grade} and total resistance may be computed by means of equations [13]-[18] and [25] through [31] or [32] through [40]. Proceeding with this analysis, k₁=0.0084, k₂=2.463×10⁻⁷ s²-m⁻², and k₃=0.289 kgf-s²-m⁻².

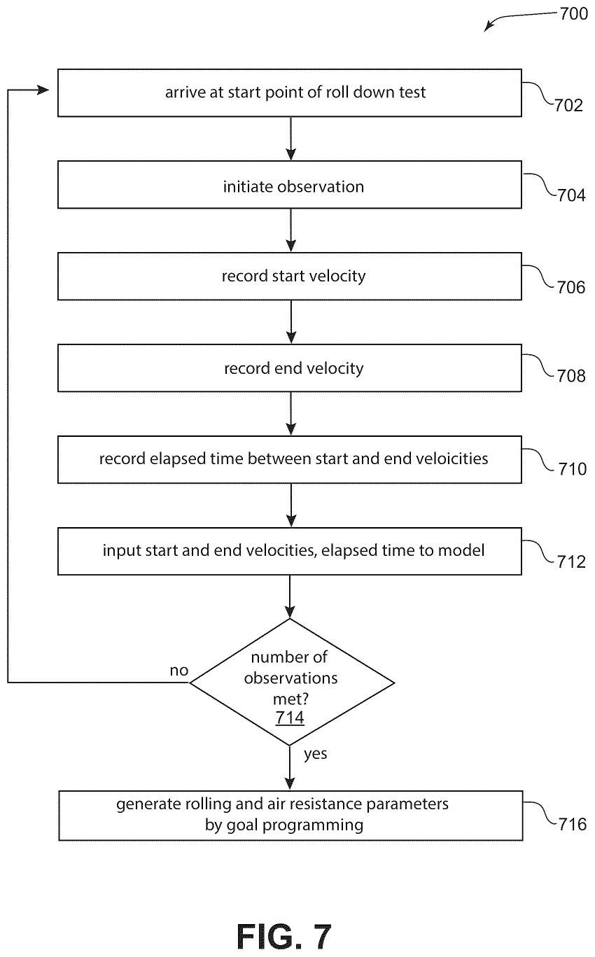

FIG. 7 illustrates a flowchart 700 for a method of performing a roll-down test for a vehicle under test using roll-down tool application 300 that applies goal programming to find rolling and air resistance parameters, in accordance with at least one embodiment.

At operation 702, the VUT arrives at the start point of the roll-down test. In some examples, the VUT is an auto manufacturer's prototype truck, SUV, or other automobile such as a sedan. For testing purposes, the VUT may have a scheduled rendezvous at a predetermined test strip for performing the roll-down test to evaluate the aerodynamic design of the VUT. In some examples, the VUT operator decides to test the vehicle at will. The VUT operator may arrive at a known roll-down test strip or find one at random. In this way, the roll-down test may be performed on any type of grade, road surface and weather conditions. In some embodiments, a roll-down test may be commanded from a central office or other location. For example, a VUT may be tracked by relaying GPS coordinates of the VUT by cellular connectivity. A computerized system may map the trajectory of the VUT and autonomously trigger a roll-down test when the VUT arrives at an established test strip or at a random test strip when the VUT approaches a suitable road segment to perform the roll-down test.

At operations 704 and 706, a roll-down test is initiated once the VUT arrives at a suitable starting point. The initiation of the roll-down test may be autonomously triggered over a remote network (e.g. remote network 236, FIG. 2), or the operator(s) of the VUT may manually trigger the roll-down test. Upon initiation, the VUT leaves the start point and the starting velocity of the VUT may be captured and recorded. A timer may be simultaneously started for the elapsed time. Determination of arrival at a start point may be by GPS coordinates of the VUT. In at least one embodiment, for a test strip that has predetermined start and end points, an on-board receiving module in the form of an electronic detector may be employed such that a timer may be triggered when the VUT reaches or passes the detector. The initial velocity of the VUT may also be simultaneously recorded with the start time. An electronic detector may be a radar, a magnetic detector, a light detector, such as an infrared light or white light. Here, the signal is emitted when the VUT crosses a path of the light and breaks contact with a photodetector. A sonar type of acoustic detector may also be employed, where a sonar can determine position of the VUT by distance and speed measurement. The start point mark signal may be communicated to the on-board data processing module (e.g., data processing module 202), or communicated to a remote server on a cloud-based network (e.g., remote network 236). Both the starting time and initial velocity of the VUT may be recorded upon receipt of the mark signal.

At operations 708 and 710, the endpoint of the roll-down test strip is reached when the VUT arrives at the endpoint, which may be predetermined at a test strip or by attainment of a predetermined elapsed time, a distance traveled, or an end velocity. In some embodiments, GPS coordinates of the VUT may be monitored and recorded. GPS coordinates of the VUT may be matched to pre-established GPS coordinates of a start and endpoint, for example, to determine when the VUT has reached either location. Here, the end velocity of the VUT is captured and recorded, as well as the elapsed time that has passed between start and end. In at least one embodiment, the endpoint may be determined by a predetermined terminal velocity that has been reached. In other embodiments, the endpoint may be a predetermined elapsed time, where the end velocity is recorded at a predetermined elapsed time mark. In other embodiments, the endpoint may be a set distance travelled. For example, GPS coordinates of the VUT may be obtained every 100 milliseconds, enabling a determination of distance travelled along the road segment or test strip. In some embodiments, an operator may manually trigger an endpoint after passing a signpost or other visual signal. In some embodiments, a test strip may include an electronic detector, such as a radar, magnetic, acoustic, or light detector placed at a known distance from the start point to determine when the VUT has reached the endpoint. Here, a signal from the detector may record the finish time with high accuracy. The end-point detector signal may be communicated to the on-board data processing module (e.g., data processing module 202), or communicated to a remote server on a cloud-based network (e.g., remote network 236).

In addition to elapsed time and end velocity, the average grade or slope of the road segment may also be recorded. In at least one embodiment, measurement of slope angle of the road segment may be performed by a tilt sensor (e.g., tilt sensor 228), which may be gyroscope or electronic tilt sensor that continuously monitors a tilt angle of the VUT with respect to a horizontal or flat plane. Slope may also be measured using LIDAR sensors by determining the angle between the terrain surface and a horizontal plane which could be mounted on the vehicle. Grade or slope angle of the road segment may also be obtained from GIS data, for example, data extracted from a digital road map. The slope angle may be averaged if some variation of the angle, as shown in FIG. 5, is encountered by the VUT.

At operation 712, the initial velocity, end velocity and elapsed time, and grade slope angle may be input to the roll-down test tool application 300. For example, for each observation, initial velocity, end velocity and elapsed time, and slope angle may be tabulated in a spreadsheet file or simply input as a data set that is fed to the roll-down test tool at block 304 of the software process flow chart shown in FIG. 3. In at least one embodiment, multiple observations may be scheduled over a particular test strip or road segment. Here, the roll-down test tool application may be programmed to collect data from a minimum number of observations, or from a predetermined number of the multiple observations.

At operation 714, in at least one embodiment, the software flow reaches a decision block, where the tool determines if a predetermined number of observations have been completed. If this is not the case, the process flow returns to operation 702. At operation 702, the VUT arrives at the same start point of a test strip or may continue to follow a particular road to a different road segment. Another roll-down test observation may be re-initiated at the initial start point or at a different start point.

In at least one embodiment, when the number of observations is completed, process flow is directed to operation 716. At operation 716, the computational engine of roll-down tool application 300 may be run to obtain forward motion resistance parameters. In at least one embodiment, the software process flow follows the process flow example shown in FIG. 3. In at least one embodiment, a goal programming model is employed, as noted above, to find at least one feasible solution to equation [21] of the model, which is an equation of motion. Here, epsilon values are added to equation [21], as shown by equations of motion [22] and [23] to account for deviations due to measurement errors in the input data. While two equations of motion ([22] and [23]) are shown in the above derivation, where two equations would be required as a minimum criterion for number of observations, a similar equation for each observation is created. In the goal programming model, each equation has an epsilon term to account for any measurement error. In at least one embodiment, the goal programming model computes the sum of the deviations (e.g., see equation [24]) and finds a minimum of the sum in an iterative manner. When a summation minimum is found, forward motion resistance parameters α and b are computed by simultaneous solution of the model equations. When a feasible solution is found for the set of equations, parameters α and b are calculated. Once these parameters are determined, coefficients k₁, k₂, and k₃ may be determined, leading to computations of R_{rolling}, Rₐᵢᵣ, and R_{grade}. In at least one embodiment, these numbers may be employed to determine energy costs of running the VUT over different terrains and road types.

Here, some methods and devices may be shown in block diagram form, rather than in detail, to avoid obscuring present disclosure. Reference throughout this specification to “an example,” “one example,” or “some examples” means that a particular feature, structure, function, or characteristic described in connection with an example is included in at least one example of disclosure. Thus, appearances of phrase “in an example,” “in one example,” “in at least one example,” or “some examples” in various places throughout this specification are not necessarily referring to same example of disclosure. Furthermore, particular features, structures, functions, or characteristics can be combined in any suitable manner in one or more examples. For example, a first example can be combined with a second example anywhere particular features, structures, functions, or characteristics associated with two examples are not mutually exclusive. A list of definitions follows, whereby following definitions may provide or augment literal support for claims.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used to describe functional or structural relationships between components. These terms are not intended as synonyms for each other. Rather, in particular examples, “connected” may be used to indicate that two or more elements are in direct physical, optical, or electrical contact with each other. “Coupled” may be used to indicate that two or more elements are in either direct or indirect (with other intervening elements between them) physical, electrical, or magnetic contact with each other, and/or that two or more elements co-operate or interact with each other (e.g., as in a cause-and-effect relationship). “Coupled” may also have the meaning of non-mechanical contact or connection. “Coupling” may also mean: thermal connectivity, where one object may be a heat source and another object may be a heat sink, either in thermal equilibrium with each other or subject to a common conductive, convective, or radiative heat flow between them; electrical coupling, where objects may be connected electrically in an electric or electronic circuit and a current flow may be induced by application of a voltage between the electrically interconnected objects or by an electric field between mechanically coupled or isolated objects; magnetic coupling, where two mechanically coupled or isolated objects mutually share a common magnetic field flux; and fluidical coupling, where objects such as vessels and conduits may share a common gas or liquid fluid, that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis, or y-axis of a device. A material that is between two other materials may be in contact with one or both of those materials. In another example, a material that is between two or more materials may be separated from both of other two materials by one or more intervening materials. A material “between” two other materials may therefore be in contact with either of the other two materials. In another example, a material “between” two other materials may be coupled to the other two materials through an intervening material. A device that is between two other devices may be directly connected to one or both of those devices. In another example, a device that is between two other devices may be separated from both of the other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” the second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one example, such variation is no more than +/−10% of referred value.

In the following paragraphs, examples are provided that illustrate various examples. Examples can be combined with other examples. As such, various examples can be combined with other examples without changing scope of disclosure.

Example 1 is an apparatus comprising a data processing module on board a vehicle; a sensor network on-board the vehicle, the sensor network comprising one or more vehicle sensors coupled to the data processing module; a global positioning system (GPS) receiver coupled to the data processing module; a human-machine interface (HMI) module coupled to the data processing module; and a non-transitory storage medium coupled to the data processing module, wherein the non-transitory storage medium contains a set of executable instructions stored thereon, wherein the set of executable instructions includes a computational model for solving a set of equations of motion of the vehicle, wherein the computational model is configured to implement a goal programming model wherein one or more feasible solutions for the set of equations of motion are computed by minimizing deviations due to measurement errors of an initial velocity and an end velocity and an elapsed time for each of two or more observations of a roll-down test.

Example 2 is an apparatus as in any of the examples, in particular example 1, wherein the one or more vehicle sensors are configured to determine any of vehicular velocity, engine speed, wheel speed, transmission gear ratio, and vehicle tilt angle of the vehicle.

Example 3 is an apparatus as in any of the examples, in particular example 1, wherein the one or more vehicle sensors are configured to determine tire pressure of one or more tires of the vehicle.

Example 4 is an apparatus as in any of the examples, in particular example 1, wherein a portable weather station is coupled to the data processing module.

Example 5 is an apparatus as in any of the examples, in particular example 1, wherein the data processing module is coupled to a remote network, wherein the remote network comprises a remote database.

Example 6 is an apparatus as in any of the examples, in particular example 5, wherein the data processing module is coupled to the remote network via a remote network link on the HMI module.

Example 7 is an apparatus as in any of the examples, in particular example 5, wherein the remote database stores one or more digital road maps that provide a set of geographical information system (GIS) data to the data processing module, and wherein the data processing module is configured to combine one or more sets of GPS coordinates obtained by the GPS receiver with the set of GIS data to determine a position of the vehicle on a digital road map of the one or more digital road maps.

Example 8 is an apparatus as in any of the examples, in particular example 7, wherein the set of GIS data comprises road grade data.

Example 9 is a system comprising: a vehicle; and a data collection system within the vehicle, wherein the data collection system comprises: a data processing module for collecting sensor data of the vehicle; a sensor network on-board the vehicle, the sensor network comprising one or more vehicle sensors coupled to the data processing module; a global positioning system (GPS) receiver coupled to the data processing module; and a human-machine interface (HMI module) module coupled to the data processing module; and a non-transitory storage medium coupled to the data processing module, wherein the non-transitory storage medium contains a set of executable instructions stored thereon, wherein the set of executable instructions includes a computational model for solving a set of equations of motion of the vehicle, wherein the computational model is configured to implement a goal programming model wherein one or more feasible solutions for the set of equations of motion of the vehicle are computed by minimizing deviations due to measurement errors of an initial velocity and an end velocity and an elapsed time for each of two or more observations of a roll-down test.

Example 10 is a system as in any of the examples, in particular example 9, further comprising a receiver module that is configured to receive a wireless signal from a transmitter external to the vehicle, wherein the receiver module is configured to trigger a start or an end to a data acquisition process performed by the data processing module upon reception of the wireless signal.

Example 11 is a system as in any of the examples, in particular example 10, wherein the data processing module is configured to acquire data from any of the one or more vehicle sensors, wherein the one or more vehicle sensors is configured to determine any of vehicular velocity, engine speed, wheel speed, transmission gear ratio, tire pressure and vehicle tilt angle of the vehicle.

Example 12 is a system as in any of the examples, in particular example 9, wherein the data collection system is coupled to a remote network, wherein the remote network is configured to acquire data from any of the one or more vehicle sensors, wherein the one or more vehicle sensors is configured to determine any of vehicular velocity, engine speed, wheel speed, transmission gear ratio, tire pressure, and vehicle tilt angle of the vehicle.

Example 13 is a system as in any of the examples, in particular example 12, wherein the data collection system is coupled to the remote network via the HMI module, wherein the HMI module is one of a laptop computer, a tablet computer, or a smartphone.

Example 14 is a method for conducting a roll-down test observation of a vehicle, comprising executing instructions by one or more processors coupled to one or more memories in which a set of executable instructions are stored on at least one of the one or more memories coupled to a data processing module on-board the vehicle, wherein the data processing module is coupled to a sensor network on-board the vehicle, wherein the set of executable instructions result in: arriving at a start point of a roll-down test of the vehicle; leaving the start point of the roll-down test and recording an initial velocity of the vehicle at the start point of the roll-down test; arriving at an endpoint of the roll-down test recording an end velocity of the vehicle at the endpoint of the roll-down test; recording an elapsed time between leaving the start point and arriving at the endpoint of the roll-down test; inputting the initial velocity of the vehicle, the end velocity of the vehicle, and the elapsed time to a computational model; and generating, by the computational model, one or more rolling and air resistance parameters.

Example 15 is a method as in any of the examples, in particular example 14, wherein the set of executable instructions include the computational model for solving a set of equations of motion of the vehicle, wherein the computational model is configured to implement a goal programming model wherein one or more feasible solutions for the set of equations of motion are computed by minimizing deviations due to measurement errors of the initial velocity and the end velocity and the elapsed time for each of two or more observations of a roll-down test.

Example 16 is a method as in any of the examples, in particular example 15, wherein generating, by the computational model, the one or more rolling and air resistance parameters comprises solving two or more equations of motion of the vehicle by the computational model, each of the two or more equations of motion having a first unknown variable and a second unknown variable, wherein a first deviation variable is added to a first equation of motion of the two or more equations of motion, and a second deviation variable is added to a second equation or motion of the two or more equations of motion, wherein the computational model minimizes a sum of the first and second deviation variables to find the one or more feasible solutions of the first unknown variable and the second unknown variable.

Example 17 is a method as in any of the examples, in particular example 14, wherein recording the initial velocity and the end velocity of the vehicle comprises triggering the data processing module to query a sensor within the vehicle, wherein the sensor is configured to obtain a vehicular velocity of the vehicle.

Example 18 is a method as in any of the examples, in particular example 17, wherein triggering the data processing module to query the sensor within the vehicle, wherein the sensor is configured to obtain the vehicular velocity of the vehicle comprises receiving a first signal by a receiver module within the vehicle, wherein the receiver module sends a second signal to the data processing module.

Example 19 is a method as in any of the examples, in particular example 14, further comprising recording one or more tilt angles of the vehicle during travel of the vehicle from the start point to the endpoint, and inputting the one or more tilt angles of the vehicle to the computational model.

Example 20 is a method as in any of the examples, in particular example 19, wherein recording the one or more tilt angles of the vehicle during the travel of the vehicle from the start point to the endpoint comprises querying a sensor configured to measure the one or more tilt angles of the vehicle during the travel of the vehicle from the start point to the endpoint.

Example 21 is a method as in any of the examples, in particular example 14, wherein arriving at the start point of the roll-down test comprises recording a first set of global positioning system (GPS) coordinates of the vehicle and matching the first set of GPS coordinates to a second set of GPS coordinates, wherein the second set of GPS coordinates indicate a location of the start point of the roll-down test.

Besides what is described herein, various modifications can be made to disclose examples and examples thereof without departing from their scope. Therefore, illustrations of examples herein should be construed as examples, and not restrictive to scope of present disclosure.

What is claimed is:

1. An apparatus comprising:
a data processing module on board a vehicle;
a sensor network on-board the vehicle, the sensor network comprising one or more vehicle sensors coupled to the data processing module;
a global positioning system (GPS) receiver coupled to the data processing module;
a human-machine interface (HMI) module coupled to the data processing module; and
a non-transitory storage medium coupled to the data processing module, wherein the non-transitory storage medium contains a set of executable instructions stored thereon, wherein the set of executable instructions includes a computational model for solving a set of equations of motion of the vehicle, wherein the computational model is configured to implement a goal programming model wherein one or more feasible solutions for the set of equations of motion are computed by minimizing deviations due to measurement errors of an initial velocity and an end velocity and an elapsed time for each of two or more observations of a roll-down test.

2. The apparatus of claim 1, wherein the one or more vehicle sensors are configured to determine any of vehicular velocity, engine speed, wheel speed, transmission gear ratio and vehicle tilt angle of the vehicle.

3. The apparatus of claim 1, wherein the one or more vehicle sensors are configured to determine tire pressure of one or more tires of the vehicle.

4. The apparatus of claim 1, wherein a portable weather station is coupled to the data processing module.

5. The apparatus of claim 1, wherein the data processing module is coupled to a remote network, wherein the remote network comprises a remote database.

6. The apparatus of claim 5, wherein the data processing module is coupled to the remote network via a remote network link on the HMI module.

7. The apparatus of claim 5, wherein the remote database stores one or more digital road maps that provide a set of geographical information system (GIS) data to the data processing module, and wherein the data processing module is configured to combine one or more sets of GPS coordinates obtained by the GPS receiver with the set of GIS data to determine a position of the vehicle on a digital road map of the one or more digital road maps.

8. The apparatus of claim 7, wherein the set of GIS data comprises road grade data.

9. A system, comprising:
a vehicle; and
a data collection system within the vehicle, wherein the data collection system comprises:
a data processing module for collecting sensor data of the vehicle;
a sensor network on-board the vehicle, the sensor network comprising one or more vehicle sensors coupled to the data processing module;
a global positioning system (GPS) receiver coupled to the data processing module; and
a human-machine interface (HMI module) module coupled to the data processing module; and
a non-transitory storage medium coupled to the data processing module, wherein the non-transitory storage medium contains a set of executable instructions stored thereon, wherein the set of executable instructions includes a computational model for solving a set of equations of motion of the vehicle, wherein the computational model is configured to implement a goal programming model wherein one or more feasible solutions for the set of equations of motion of the vehicle are computed by minimizing deviations due to measurement errors of an initial velocity and an end velocity and an elapsed time for each of two or more observations of a roll-down test.

10. The system of claim 9, further comprising a receiver module that is configured to receive a wireless signal from a transmitter external to the vehicle, wherein the receiver module is configured to trigger a start or an end to a data acquisition process performed by the data processing module upon reception of the wireless signal.

11. The system of claim 10, wherein the data processing module is configured to acquire data from any of the one or more vehicle sensors, wherein the one or more vehicle sensors is configured to determine any of vehicular velocity, engine speed, wheel speed, transmission gear ratio, tire pressure and vehicle tilt angle of the vehicle.

12. The system of claim 9, wherein the data collection system is coupled to a remote network, wherein the remote network is configured to acquire data from any of the one or more vehicle sensors, wherein the one or more vehicle sensors is configured to determine any of vehicular velocity, engine speed, wheel speed, transmission gear ratio, tire pressure and vehicle tilt angle of the vehicle.

13. The system of claim 12, wherein the data collection system is coupled to the remote network via the HMI module, wherein the HMI module is one of a laptop computer, a tablet computer or a smartphone.

14. A method for conducting a roll-down test observation of a vehicle, comprising:
executing instructions by one or more processors coupled to one or more memories in which a set of executable instructions are stored on at least one of the one or more memories coupled to a data processing module on-board the vehicle, wherein the data processing module is coupled to a sensor network on-board the vehicle, wherein the set of executable instructions result in:
arriving at a start point of a roll-down test of the vehicle;
leaving the start point of the roll-down test and recording an initial velocity of the vehicle at the start point of the roll-down test;
arriving at an endpoint of the roll-down test recording an end velocity of the vehicle at the endpoint of the roll-down test;
recording an elapsed time between leaving the start point and arriving at the endpoint of the roll-down test;
inputting the initial velocity of the vehicle, the end velocity of the vehicle, and the elapsed time to a computational model; and
generating, by the computational model, one or more rolling and air resistance parameters.

15. The method of claim 14, wherein the set of executable instructions include the computational model for solving a set of equations of motion of the vehicle, wherein the computational model is configured to implement a goal programming model wherein one or more feasible solutions for the set of equations of motion are computed by minimizing deviations due to measurement errors of the initial velocity and the end velocity and the elapsed time for each of two or more observations of a roll-down test.

16. The method of claim 15, wherein generating, by the computational model, the one or more rolling and air resistance parameters comprises solving two or more equations of motion of the vehicle by the computational model, each of the two or more equations of motion having a first unknown variable and a second unknown variable, wherein a first deviation variable is added to a first equation of motion of the two or more equations of motion, and a second deviation variable is added to a second equation or motion of the two or more equations of motion, wherein the computational model minimizes a sum of the first and second deviation variables to find the one or more feasible solutions of the first unknown variable and the second unknown variable.

17. The method of claim 14, wherein recording the initial velocity and the end velocity of the vehicle comprises triggering the data processing module to query a sensor within the vehicle, wherein the sensor is configured to obtain a vehicular velocity of the vehicle.

18. The method of claim 17, wherein triggering the data processing module to query the sensor within the vehicle, wherein the sensor is configured to obtain the vehicular velocity of the vehicle comprises receiving a first signal by a receiver module within the vehicle, wherein the receiver module sends a second signal to the data processing module.

19. The method of claim 14, further comprising recording one or more tilt angles of the vehicle during travel of the vehicle from the start point to the endpoint, and inputting the one or more tilt angles of the vehicle to the computational model.

20. The method of claim 19, wherein recording the one or more tilt angles of the vehicle during the travel of the vehicle from the start point to the endpoint comprises querying a sensor configured to measure the one or more tilt angles of the vehicle during the travel of the vehicle from the start point to the endpoint.

21. The method of claim 14, wherein arriving at the start point of the roll-down test comprises recording a first set of global positioning system (GPS) coordinates of the vehicle and matching the first set of GPS coordinates to a second set of GPS coordinates, wherein the second set of GPS coordinates indicate a location of the start point of the roll-down test.
